(19) United States
(12) Patent Application Publication
(10) Pub. No.: US 2009/0010476 A1
(43) Pub. Date: Jan. 8, 2009

(54) EARPHONE ASSEMBLY WITH AUDIO RECEPTACLE

(76) Inventor: Kenneth Pan, Taipei (TW)

Correspondence Address: Kenneth Pan, 235 Chung-Ho, Box 8-24, Taipei, TW

(21) Appl. No.: 11/772,828

(22) Filed: Jul. 3, 2007

(51) Int. Cl. H04R 25/00

(52) U.S. Cl. 381/382

(57) ABSTRACT

An earphone assembly with an audio receptacle, comprises a connecting portion suitable for locating the earphone assembly upon the head of a user; two ear masks installed at two ends of the connecting portion; a seat being installed at one of the mask or at the connecting portion; an insertion hole being formed in the seat as an audio receptablce for receiving an audio plug; and a connecting wire having two plugs at two ends thereof; one audio plug being able to connect with the insertion hole of the seat. Moreover, the seat can be replaced by a prolong wire and the insertion hole is formed in the prolong wire.

### FIELD OF THE INVENTION

The present invention relates to earphones, and particularly to an earphone assembly with an audio receptacle which is suitable for the connecting wire with different specification. The earphone assembly of the present invention is suitable for two different kinds of the audio plugs so that it has wider applications.

### BACKGROUND OF THE INVENTION

Walkman has developed to have various forms for suiting the digital trend, such as MP3, iPod. Thus the related components are developed to suit for this new device, for example earphones. Compact earplug form earphones or foldable earphones are developed. However the audio connection of the earphone is not changed nowadays.

Referring to FIG. 1, a prior art earphone is illustrated. An earphone 10 has a mask 12. The mask 12 has a connecting wire 14. A middle section of the mask 14 has a controller 16 for volume control, device actuation and stop. The plug 18 used is a USB plug.

Referring to FIG. 2, another prior art form earphone is illustrated. The earphone 10′ has a mask 12′ which has a connecting wire 14′. The connecting wire 14′ has a plug 18′ which is a 3.5 mm audio plug which can be inserted into a walkman, an MP3, a mini stereo, etc. Furthermore, a connecting wire 20 with a receptacle 22 and an audio plug 24 is used to extend the using length of the earphone.]

Referring to FIGS. 1 and 2, the prior art earphone has fixed connections which are suitable only one kind of connecting wire with a specific specification. It is not suitable for the connecting wire of different specification.

### SUMMARY OF THE INVENTION

Accordingly, the primary object of the present invention is to provide a earphone assembly with an audio receptacle which is suitable of the connecting wire with different specification.

Furthermore, the earphone assembly with an audio receptacle is suitable for two different kinds of the audio plugs so that the cost is reduced.

To achieve above objects, the present invention provides an earphone assembly with an audio receptacle, comprising: a connecting portion suitable for locating the earphone assembly upon the head of a user; two ear masks installed at two ends of the connecting portion; a seat being installed at one of the mask or at the connecting portion; an insertion hole being formed in the seat as an audio receptablce for receiving an audio plug; and a connecting wire having two plugs at two ends thereof; one audio plug being able to connect with the insertion hole of the seat.

Furthermore, the present invention provides an earphone assembly with an audio receptacle, comprising: a connecting portion suitable for locating the earphone assembly upon the head of a user; two ear masks installed at two ends of the connecting portion; a prolong wire being installed at one of the mask or at the connecting portion; an insertion hole being formed in the prolong wire as an audio receptablce for receiving an audio plug; and a connecting wire having two audio plugs at two ends thereof; one audio plug being able to connect with the insertion hole of the prolong wire.

The various objects and advantages of the present invention will be more readily understood from the following detailed description when read in conjunction with the appended drawing.

### BRIEF DESCRIPTION OF THE DRAWINGS

FIG. 1 is a schematic view showing that a USB plug is connected to an earphone.

FIG. 2 is a schematic view showing that a general audio stereo is connected to an earphone.

FIGS. 3A and 3B are schematic views showing that the insertion hole of the present invention is used to be connected to a connecting wire with a USB plug.

FIGS. 4A and 4B are schematic views showing that the insertion hole of the present invention is used to be connected to a connecting wire with an audio plug.

FIG. 5 is a schematic view showing that a prolong wire is extended from the ear mask for being connected to a connecting wire.

FIGS. 6A and 6B are schematic views showing that the prolong wire of the present invention is used to be connected to a connecting wire with a USB plug.

FIGS. 7A and 7B are schematic views showing that the prolong wire of the present invention is used to be connected to a connecting wire with an audio plug.

FIG. 8 shows that the prolong wire extends from the ear mask of an earphone and an extension wire is used to prolong the connecting wire which is engaged to the prolong wire.

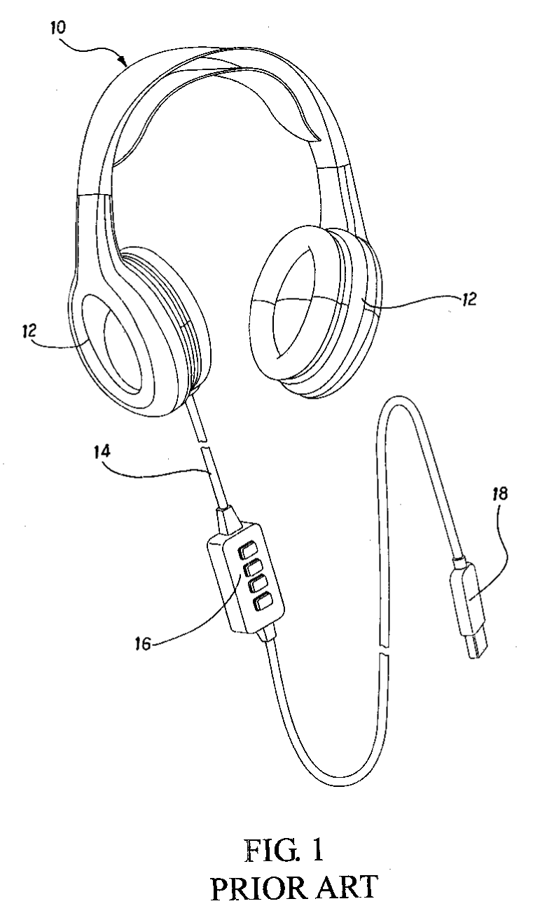

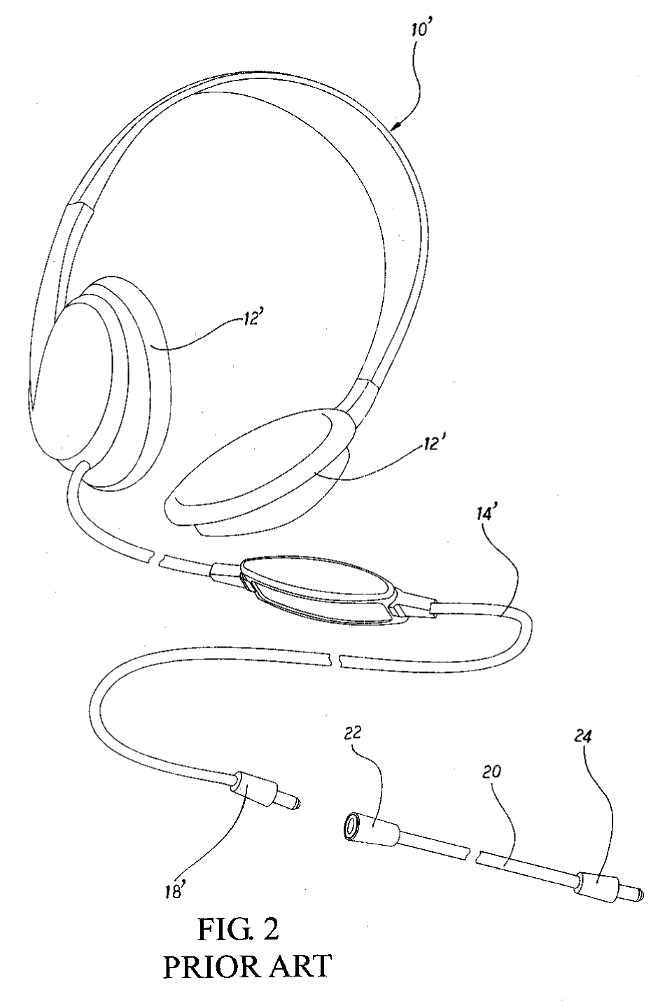

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

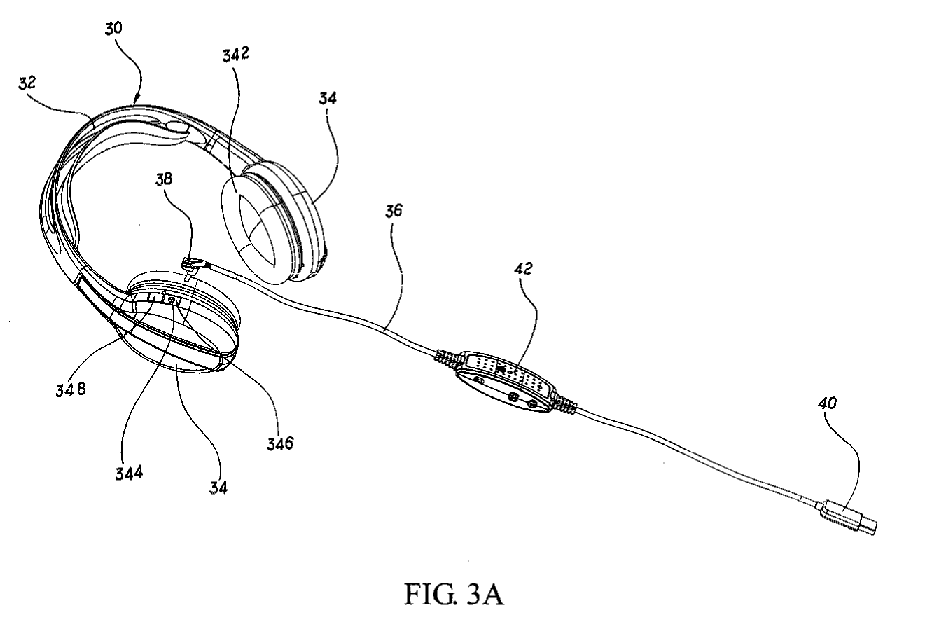

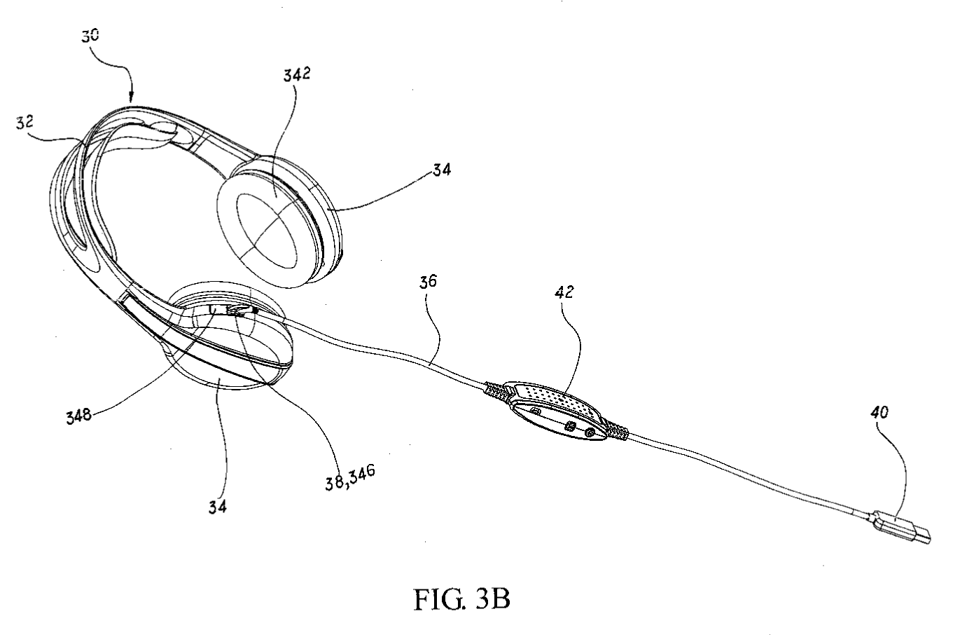

Referring to FIGS. 3A and 3B, the earphone assembly of the present invention has the following elements.

A connecting portion 32 is suitable for locating the earphone assembly upon the head of a user. The connecting portion 32 may be a telescopic structure for adjusting the sizes thereof.

Two ear masks 34 are installed at two ends of the connecting portion 32. A side of each ear mask 34 facing to another ear mask 34 is adhered with a soft cushion 342. An inner side of the soft cushion 342 is generally installed with sound absorbing material for absorbing sound. Preferably, the connecting portion 32 is made of elastic metal or plastic. The elastic force from the connecting portion 32 will cause the soft cushions 342 to seal the ears of the user so as to isolate the external sound.

One of the two ear masks 34 is formed with a seat 346. An insertion hole 344 is formed in the seat 346. However the seat and insertion hole can be formed on the connecting portion, this case also includes in the present invention. In this embodiment, the insertion hole 344 and seat 346 are formed on the ear mask 34 as an example. The insertion hole 344 serves for receiving an audio plug (such as a 3.5 mm plug). The seat 346 has a wedge shape for fixing the plug connected to the insertion hole 344. Besides, the a cover 348 can be installed to an external side of the seat 346 and insertion hole 344 for dust-proof.

In this embodiment, one end of the connecting wire 36 is installed with a standard audio plug 38 (3.5 mm plug). Another end thereof is installed with a USB (universal serial bus) plug 40 which are widely used in computers or audio devices so that the applications are wider. However the forms of the plugs are not confined by USB or audio plug, other form is permissible and is within the scope of the present invention. Digital audio signals from USB plug 40 is controlled by a controller 42 at a middle section of the connecting wire 36 so as to adjust the volume of the input signals. The audio plug 38 of the connecting wire 36 is connected to the insertion hole 344 in the seat 346 so that the audio plug 38 can be firmly secured to the ear mask 34.

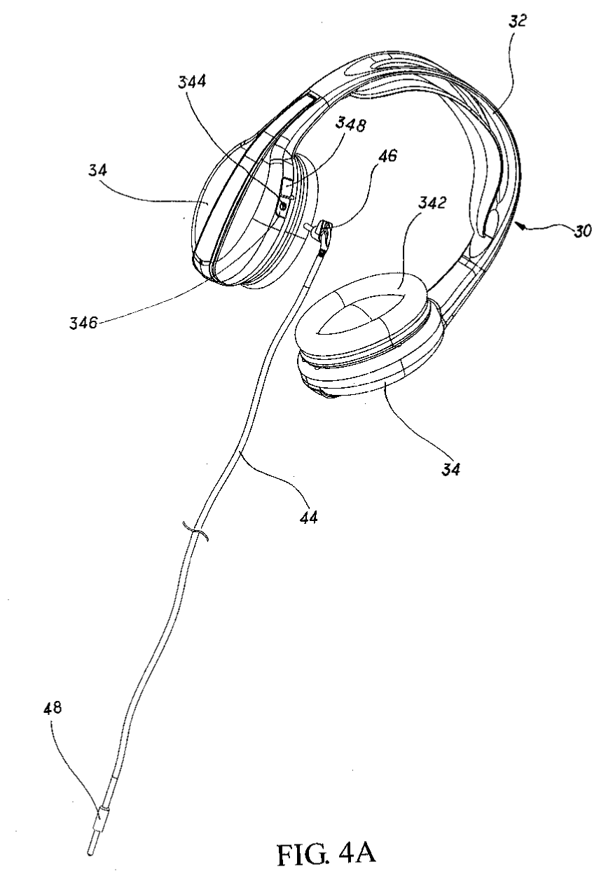

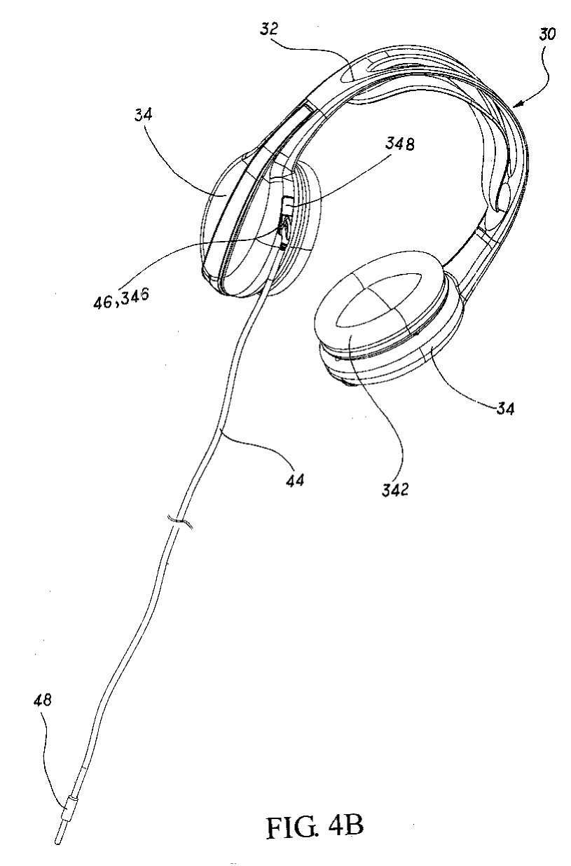

Referring to FIGS. 4A and 4B, another embodiment of the present invention is illustrated. In this embodiment, those identical to the above embodiment will not be further described herein. Only those different from above embodiment are described. In this embodiment, the ear masks 34, connecting portion 32, seat 346, insertion hole 344 and cover 348 are identical to the embodiment illustrated in FIG. 3. The difference is that the connecting wire 44 has two audio plugs 46, 48 which are standard audio plugs (such as 3.5 mm or 6.3 mm or other specification standard audio plugs).

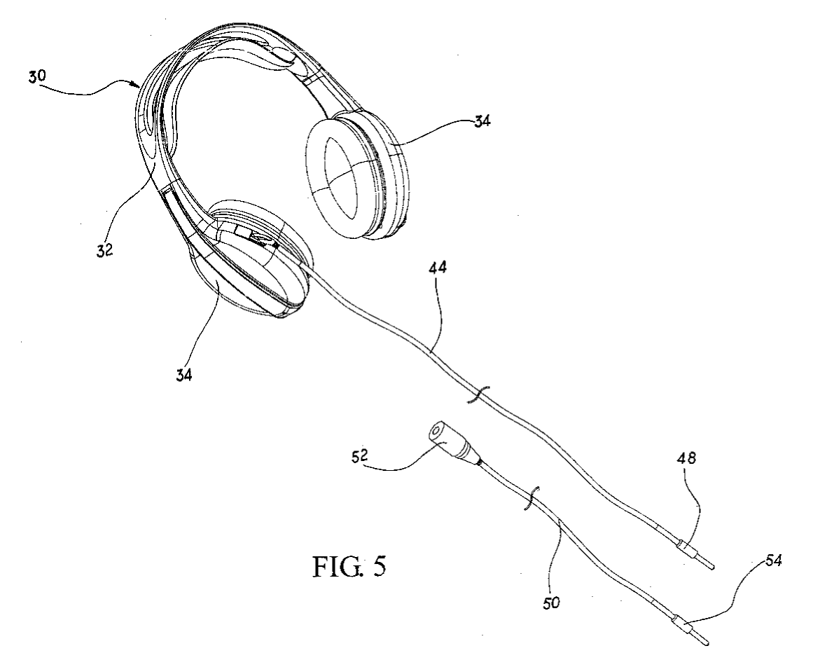

Referring to FIG. 5, the application of the present invention is illustrated. In FIG. 5, an extension wire 50 is used to be serially connected with the connecting wire 40 (see FIG. 4A). One end of the extension wire 50 has an adaptor which is engageable to the audio plug 48 of the connecting wire 36. The audio plug 54 at another end of the extension wire 50 is a standard audio plug or a USB plug so that the extension wire 50 has the function of extension the distance of the earphone or changing the form of the plug.

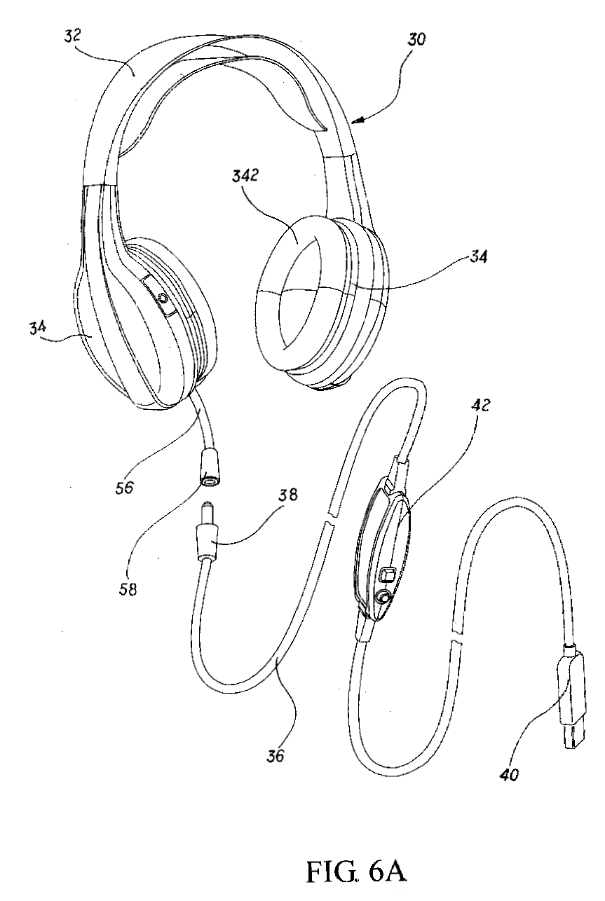

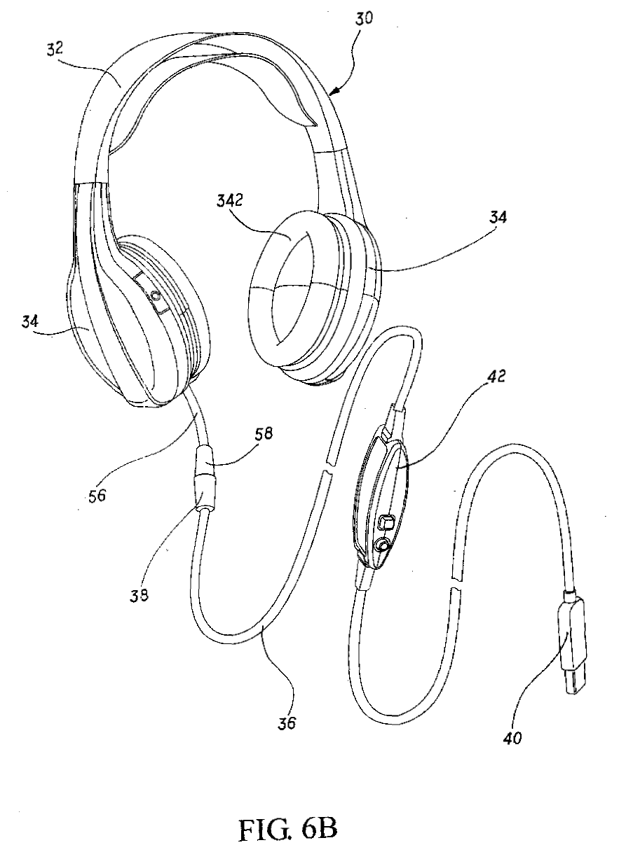

Referring to FIGS. 6A and 6B, a connecting portion 32 is suitable for locating the earphone assembly upon the head of a user.

Two ear masks 34 are installed at two ends of the connecting portion 32. A side of each ear mask 34 facing to another ear mask 34 is adhered with a soft cushion 342. An inner side of the soft cushion 342 is generally installed with sound absorbing material for absorbing sound.

One of the two ear masks 34 is extended with a prolong wire 56. An insertion hole 58 as a receptacle is formed in the prolong wire. However the seat and insertion hole can be formed on the connecting portion, this case also includes in the present invention. The insertion hole 58 serves to receive an audio plug 38 (3.5 mm) at one end of a connecting wire 36. Another end of the connecting wire 36 is a USB plug 40 for being connected to the audio device.

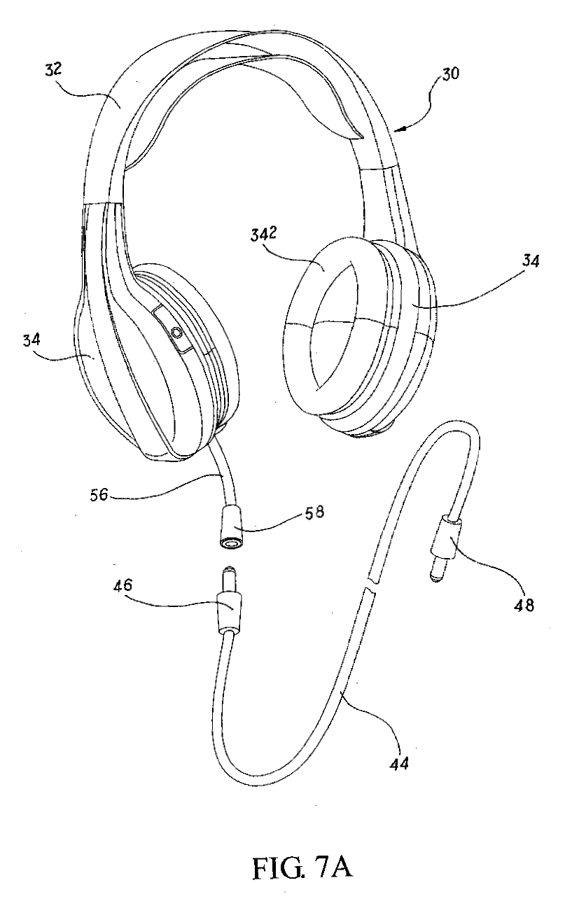

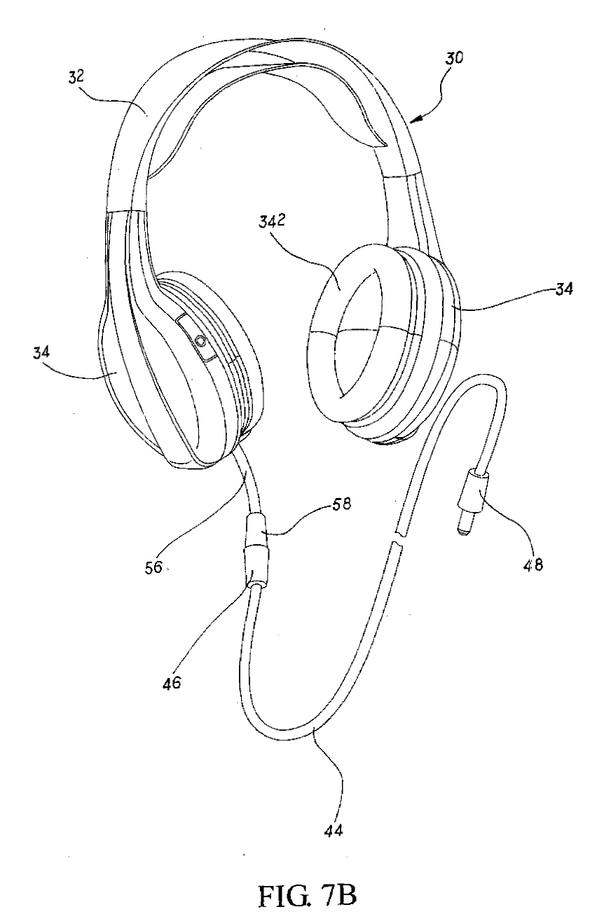

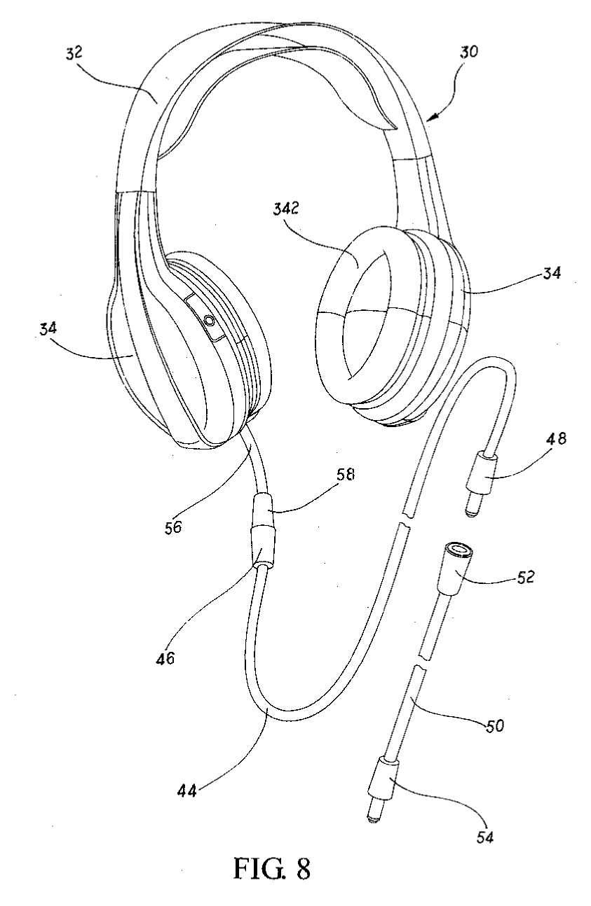

Referring to FIGS. 7A and 7B, another embodiment of the present invention is illustrated. In this embodiment, those identical to the above embodiment in FIGS. 6A and 6B will not be further described herein. Only those different from above embodiment are described. In this embodiment, one end of the connecting wire 44 is a standard audio plug 46 for engaging with the insertion hole 58 of the prolong wire 56 and another end thereof is another standard audio plug 48 suitable for general audio stereo, television, and iPod. Similarly, an extension wire 50 is used to connect with the connecting wire 44 for extending the length of the connecting wire 44, as shown in FIG. 8.

On end of the extension wire 50 is an adaptor 52 which is engageable to the audio plug 48 of the connecting wire 44. Another end thereof is an audio plug 54 which may be a 6.3 mm plug, a standard audio plug (3.5 mm) or a USB plug so that the extension wire 50 can extend the length of the connecting wire or for adapting receptacle of other specification.

However in the present invention, the seat is installed on the ear mask 34 or the prolong wire is extended from the ear mask 34, however the seat can be installed on the connecting portion 32 and the prolong wire can be extended from the connecting portion 32. All these are within the scope of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An earphone assembly with an audio receptacle, comprising:
a connecting portion suitable for locating the earphone assembly upon the head of a user;
two ear masks installed at two ends of the connecting portion;
a seat being installed at one of the mask or at the connecting portion; an insertion hole being formed in the seat as an audio receptablce for receiving an audio plug; and
a connecting wire having two plugs at two ends thereof; one audio plug being able to connect with the insertion hole of the seat.

2. The earphone assembly with an audio receptacle as claimed in claim 1, wherein another audio plug of the connecting wire is a standard audio plug.

3. The earphone assembly with an audio receptacle as claimed in claim 1, wherein one audio plug of the connecting wire is a standard audio plug and another audio plug is an USB plug.

4. The earphone assembly with an audio receptacle as claimed in claim 1, further comprising a cover covering upon the seat and insertion hole.

5. The earphone assembly with an audio receptacle as claimed in claim 1, further comprising an extension wire one end of which is connectable to one end of the connecting wire and another end of which is installed with one of a 6.3 mm audio plug, a 3.5 mm audio plug and a USB plug.

6. An earphone assembly with an audio receptacle, comprising:
a connecting portion suitable for locating the earphone assembly upon the head of a user;
two ear masks installed at two ends of the connecting portion;
a prolong wire being installed at one of the mask or at the connecting portion; an insertion hole being formed in the prolong wire as an audio receptablce for receiving an audio plug; and
a connecting wire having two audio plugs at two ends thereof; one audio plug being able to connect with the insertion hole of the prolong wire.

7. The earphone assembly with an audio receptacle as claimed in claim 6, wherein another audio plug of the connecting wire is a standard audio plug.

8. The earphone assembly with an audio receptacle as claimed in claim 6, wherein one audio plug of the connecting wire is a standard audio plug and another audio plug is an USB plug.

9. The earphone assembly with an audio receptacle as claimed in claim 1 further comprising an extension wire one end of which is connectable to one end of the connecting wire and another end of which is installed with one of a 6.3 mm audio plug, a 3.5 mm audio plug and a USB plug.
